(19) United States
(12) Patent Application Publication
(10) Pub. No.: US 2026/0292776 A1
(43) Pub. Date: Sep. 24, 2026

(54) POSITIONING ENVIRONMENT PROVIDING SYSTEM AND POSITIONING ENVIRONMENT PROVIDING METHOD

(71) Applicant: SEIKO EPSON CORPORATION, Tokyo (JP)

(72) Inventor: Maho TERASHIMA, MATSUMOTO-SHI (JP)

(73) Assignee: SEIKO EPSON CORPORATION, Tokyo (JP)

(21) Appl. No.: 19/568,854

(22) Filed: Mar. 17, 2026

(30) Foreign Application Priority Data
Mar. 18, 2025 (JP) 2025-043295

(51) Int. Cl. H04W 64/00; H04B 17/318; H04W 84/06

(52) U.S. Cl. CPC H04W 64/00; H04B 17/318; H04W 84/06

(57) ABSTRACT

A positioning environment providing system that provides, using a plurality of autonomously movable reference stations, an environment for measuring a position of a positioning target apparatus in a predetermined space, in which the plurality of reference stations include a first reference station, a second reference station, and a third reference station, the first reference station acquires a first coordinate indicating a position of the first reference station, the second reference station communicates with the first reference station to acquire a second coordinate indicating a position of the second reference station based on the first coordinate, and the third reference station communicates with the first reference station and the second reference station to acquire a third coordinate indicating a position of the third reference station based on the first coordinate and the second coordinate.

The present application is based on, and claims priority from JP Application Serial Number 2025-043295, filed Mar. 18, 2025, the disclosure of which is hereby incorporated by reference herein in its entirety.

### BACKGROUND

### 1. Technical Field

The present disclosure relates to a positioning environment providing system and a positioning environment providing method.

### 2. Related Art

JP-A-2023-81774 discloses a positioning system including a management apparatus that calculates, using a plurality of reference apparatuses installed in a positioning target space, a position of a positioning target apparatus in the positioning target space. In the positioning target space, an installation-assist apparatus is installed in which a plurality of auxiliary communication devices are provided at a plurality of auxiliary points whose coordinates are known in advance, and the management apparatus measures distances between the reference apparatuses and the plurality of auxiliary communication devices to determine coordinates of the reference apparatuses based on measurement results.

JP-A-2023-81774 is an example of the related art.

In the positioning system disclosed in JP-A-2023-81774, it is required to set the plurality of auxiliary points having the known coordinates in the positioning target space in advance and install each auxiliary communication device at each of the plurality of set auxiliary points, and there is a concern that a large number of man-hours will be required to provide a positioning environment.

### SUMMARY

One aspect of a positioning environment providing system according to the disclosure is

a positioning environment providing system that provides, using a plurality of reference stations, an environment for measuring a position of a positioning target apparatus in a predetermined space, in which

the plurality of reference stations include a first reference station, a second reference station, and a third reference station,

the first reference station is autonomously movable in the predetermined space and acquires a first coordinate indicating a position of the first reference station,

the second reference station is autonomously movable in the predetermined space and communicates with the first reference station to acquire a second coordinate indicating a position of the second reference station based on the first coordinate, and

the third reference station is autonomously movable in the predetermined space and communicates with the first reference station and the second reference station to acquire a third coordinate indicating a position of the third reference station based on the first coordinate and the second coordinate.

One aspect of a positioning environment providing method according to the disclosure is

a positioning environment providing method that provides, using a plurality of reference stations, an environment for measuring a position of a positioning target apparatus in a predetermined space, the positioning environment providing method including:

causing a first reference station among the plurality of reference stations to autonomously move in the predetermined space and acquire a first coordinate indicating a position of the first reference station;

causing a second reference station among the plurality of reference stations to autonomously move in the predetermined space and communicate with the first reference station to acquire a second coordinate indicating a position of the second reference station based on the first coordinate; and

causing a third reference station among the plurality of reference stations to autonomously move in the predetermined space and communicate with the first reference station and the second reference station to acquire a third coordinate indicating a position of the third reference station based on the first coordinate and the second coordinate.

### BRIEF DESCRIPTION OF THE DRAWINGS

FIG. 1 shows an overview of a positioning environment providing system.

FIG. 2 is a functional block diagram of a reference station.

FIG. 3 is a functional block diagram of a control apparatus.

FIG. 4 is a functional block diagram of a charging apparatus.

FIG. 5 is a functional block diagram of a positioning target apparatus.

FIG. 6 is a flowchart showing a procedure of a positioning environment providing method.

FIG. 7 is a flowchart showing a procedure of a positioning environment construction step.

FIG. 8 is a flowchart showing a processing procedure in steps S11 and S19 in FIG. 7.

FIG. 9 is a flowchart showing a processing procedure in step S12 in FIG. 7 by a reference station 10a to which ID = 1 is assigned in a first embodiment.

FIG. 10 shows a state in which placement of the reference station 10a is completed.

FIG. 11 is a flowchart showing a processing procedure in step S12 in FIG. 7 by a reference station 10b to which ID = 2 is assigned in the first embodiment.

FIG. 12 shows a state in which placement of the reference station 10b is completed.

FIG. 13 is a flowchart showing a processing procedure in step S12 in FIG. 7 by a reference station 10c to which ID = 3 is assigned in the first embodiment.

FIG. 14 shows a state in which placement of the reference station 10c is completed.

FIG. 15 is a flowchart showing a processing procedure in step S12 in FIG. 7 by a reference station to which ID = k (k ≥ 4) is assigned in the first embodiment.

FIG. 16 shows a state in which placement of a reference station 10d is completed.

FIG. 17 is a flowchart showing a processing procedure of each reference station in a positioning step.

FIG. 18 is a flowchart showing a processing procedure of the positioning target apparatus in the positioning step.

FIG. 19 shows a state during positioning of the positioning target apparatus.

FIG. 20 is a flowchart showing a processing procedure of the charging apparatus in a maintenance step.

FIG. 21 is a flowchart showing a processing procedure of a reference station with ID = m in the maintenance step.

FIG. 22 is a flowchart showing a processing procedure of a reference station with ID ≠ m in the maintenance step.

FIG. 23 is a flowchart showing a processing procedure of an exchange device in the maintenance step.

FIG. 24 shows replacement between the reference station 10a and the exchange device.

FIG. 25 is a flowchart showing a processing procedure in step S12 in FIG. 7 by the reference station 10a to which ID = 1 is assigned in a second embodiment.

FIG. 26 shows a state in which placement of the reference station 10a is completed.

FIG. 27 is a flowchart showing a processing procedure in step S12 in FIG. 7 by the reference station 10b to which ID = 2 is assigned in the second embodiment.

FIG. 28 shows a state in which placement of the reference station 10b is completed.

FIG. 29 is a flowchart showing a processing procedure in step S12 in FIG. 7 by the reference station 10c to which ID = 3 is assigned in the second embodiment.

FIG. 30 shows a state in which placement of the reference station 10c is completed.

FIG. 31 shows a state in which placement of the reference station 10d is completed.

### DESCRIPTION OF EMBODIMENTS

Hereinafter, preferred embodiments of the disclosure will be described in detail with reference to the drawings. The embodiments to be described below do not unduly limit the content of the disclosure described in the claims. In addition, not all configurations to be described below are necessarily essential component elements of the disclosure.

### 1. First Embodiment

### 1-1. Overview of Positioning Environment Providing System

FIG. 1 shows an overview of a positioning environment providing system 1 of the present embodiment. As will be described in detail below, the positioning environment providing system 1 is a system that provides an environment for measuring a position of a positioning target apparatus 40 in a predetermined space AR using a plurality of reference stations 10. In the embodiment, the space AR is an indoor space, and may alternatively be an outdoor space. The space AR is a three-dimensional space, and as shown in FIG. 1, a position in the space AR is represented by a coordinate of a three-axis coordinate system including an X axis, a Y axis, and a Z axis orthogonal to each other. The Z axis is a vertically upward axis.

As shown in FIG. 1, the positioning environment providing system 1 of the embodiment includes the plurality of reference stations 10, a control apparatus 20, and a charging apparatus 30. In FIG. 1, in the positioning environment providing system 1, the plurality of reference stations 10 include six reference stations 10a to 10f, but the number of reference stations 10 is not limited to six and may be three or more. In general, as the number of reference stations 10 increases, position calculation accuracy of the positioning target apparatus 40 is improved. The positioning environment providing system 1 may have a configuration in which a part of elements in FIG. 1 is omitted or changed, or other elements are added.

Each reference station 10 is autonomously movable in the space AR, acquires a coordinate indicating a position thereof, and transmits information on the acquired coordinate. Each reference station 10 has a function of receiving a satellite signal transmitted from each of a plurality of satellites 2 and calculating the coordinate indicating the position thereof, and a function of receiving information on a coordinate of a position of another reference station 10 and measuring a distance to the other reference station 10 to calculate the coordinate indicating the position thereof. The satellites 2 are artificial satellites traveling along a predetermined orbit above the earth and constitute a part of a GNSS. GNSS is an abbreviation for Global Navigation Satellite System. Examples of the GNSS include GPS, QZSS, EGNOS, GLONASS, GALILEO, and BeiDou. GPS is an abbreviation for Global Positioning System. QZSS is an abbreviation for Quasi Zenith Satellite System. EGNOS is an abbreviation for European Geostationary Navigation Overlay Service. GLONASS is an abbreviation for Global Navigation Satellite System. In the embodiment, each reference station 10 is a drone and can freely fly inside the space AR.

The control apparatus 20 is an apparatus that controls each reference station 10, communicates with each reference station 10, and performs processing of assigning an ID to each reference station 10, various instructions, and the like. The control apparatus 20 is, for example, a smartphone or a personal computer.

The charging apparatus 30 is an apparatus that can supply electric power to each reference station 10, and an exchange device 50 that is autonomously movable stands by at a position where the electric power can be supplied from the charging apparatus 30. For example, the exchange device 50 is coupled to the charging apparatus 30. Before a remaining battery level of any of the reference stations 10 runs out, the exchange device 50 moves to a position of the reference station 10 and becomes the reference station 10, and the reference station 10 moves to a position of the charging apparatus 30 to become the exchange device 50 and is charged. That is, the exchange device 50 has a role of backing up the reference station 10. In FIG. 1, the charging apparatus 30 is inside the space AR, and may alternatively be outside the space AR.

Upon entering the space AR, the positioning target apparatus 40 receives information on the coordinate of the position of each reference station 10, calculates a distance to each reference station 10, and calculates a coordinate indicating a position thereof based on the coordinate and the distance. The positioning target apparatus 40 is a mobile terminal such as a smartphone, and moves together with various objects such as a person or an animal. The positioning target apparatus 40 may be capable of receiving a satellite signal transmitted from each satellite 2 outside the space AR and calculating the coordinate indicating the position thereof alone.

### 1-2. Functional Configuration of Reference Station and Exchange Device 50

FIG. 2 is a functional block diagram of the reference station 10. As shown in FIG. 2, the reference station 10 includes a processor 11, a flight control unit 12, a GNSS reception unit 13, a UWB unit 14, a communication unit 15, and a proximity sensor 16. UWB is an abbreviation for "Ultra Wide Band".

The processor 11 performs control processing of the flight control unit 12, the GNSS reception unit 13, the UWB unit 14, the communication unit 15, and the proximity sensor 16 and various calculation processing.

The flight control unit 12 includes a motor 121, a battery 122, a blade 123, and a sensor 124, and controls flight of the reference station 10, which is a drone. The motor 121 is supplied with electric power from the battery 122 and generates power for rotating the blade 123. The sensor 124 is a sensor that is supplied with the electric power from the battery 122 and measures three-axis acceleration, three-axis angular velocity, and the like, and information such as three-axis acceleration and three-axis angular velocity measured by the sensor 124 is used for controlling a rotation speed of the blade 123, a posture, and the like.

The GNSS reception unit 13 includes a signal reception unit 131 and a positioning calculation unit 132, and performs processing of calculating a position thereof based on a received satellite signal. The signal reception unit 131 receives the satellite signal transmitted from each satellite 2, converts the received GHz-band satellite signal into a MHz-band signal, and further performs amplification processing, filtering processing, A/D conversion processing, and the like. The positioning calculation unit 132 demodulates a navigation message from a digital signal processed and obtained by the signal reception unit 131, and calculates a position thereof using a known method based on various information in the navigation message. The positioning calculation unit 132 generates positioning data including various information such as a position and a reception strength.

The UWB unit 14 includes a signal transmission and reception unit 141, a distance measurement calculation unit 142, and a positioning calculation unit 143, and performs processing of calculating a position thereof based on a time until a distance measurement signal transmitted to each reference station 10 is returned. The signal transmission and reception unit 141 transmits a predetermined distance measurement signal to each reference station 10 and receives a distance measurement signal returned from each reference station 10. Each reference station 10 receives the distance measurement signal by the signal transmission and reception unit 141 of the UWB unit 14, and returns the distance measurement signal to the reference station 10 that is a transmitter. The distance measurement calculation unit 142 measures the time until the distance measurement signal transmitted by the signal transmission and reception unit 141 to each reference station 10 is returned, and calculates a distance to each reference station 10 based on the measured time and a propagation speed of the distance measurement signal. The positioning calculation unit 143 calculates a position thereof using a known method such as trilateration based on distances to each of three or more reference stations 10 calculated by the distance measurement calculation unit 142.

The processor 11 controls whether to cause the GNSS reception unit 13 to calculate a position thereof or cause the UWB unit 14 to calculate the position thereof.

The communication unit 15 is an interface for the processor 11 to perform various types of communication with each reference station 10, the control apparatus 20, and the charging apparatus 30. For example, the processor 11 performs, via the communication unit 15, processing of transmitting information on the position thereof to each reference station 10 and the control apparatus 20, and processing of receiving information on positions of each reference station 10 and the charging apparatus 30.

The proximity sensor 16 is a sensor that detects a wall, a floor, a ceiling, an obstacle, and the like and measures distances to these objects. The processor 11 controls the flight control unit 12 to avoid a collision with a surrounding object based on an output signal from the proximity sensor 16.

Since the exchange device 50 has a role of backing up the reference station 10, a configuration thereof is the same as the configuration of the reference station 10 shown in FIG. 2.

### 1-3. Functional Configuration of Control Apparatus

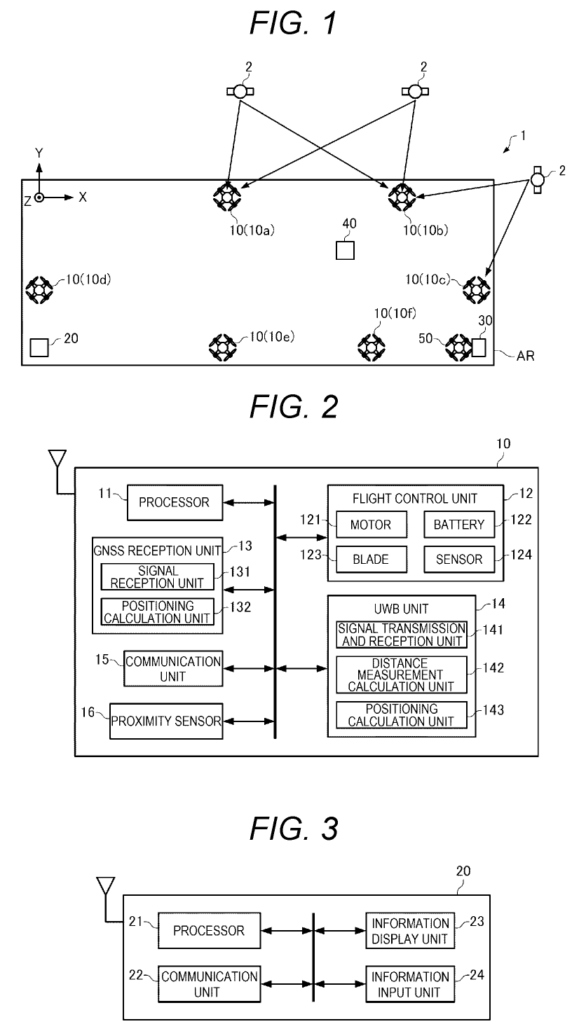

FIG. 3 is a functional block diagram of the control apparatus 20. As shown in FIG. 3, the control apparatus 20 includes a processor 21, a communication unit 22, an information display unit 23, and an information input unit 24.

The processor 21 performs control processing on the communication unit 22 and the information display unit 23 and various types of calculation processing based on information received from the information input unit 24.

The communication unit 22 is an interface for the processor 21 to perform various types of communication with each reference station 10. For example, the processor 21 performs, via the communication unit 22, processing of assigning an ID to each reference station 10, various instructions, and processing of receiving information on the position of each reference station 10.

The information display unit 23 is a device that displays information received from the processor 21, and the information input unit 24 is a device that receives various information. For example, the control apparatus 20 may include a display with a touch panel in which the information display unit 23 and the information input unit 24 are integrated.

### 1-4. Functional Configuration of Charging Apparatus

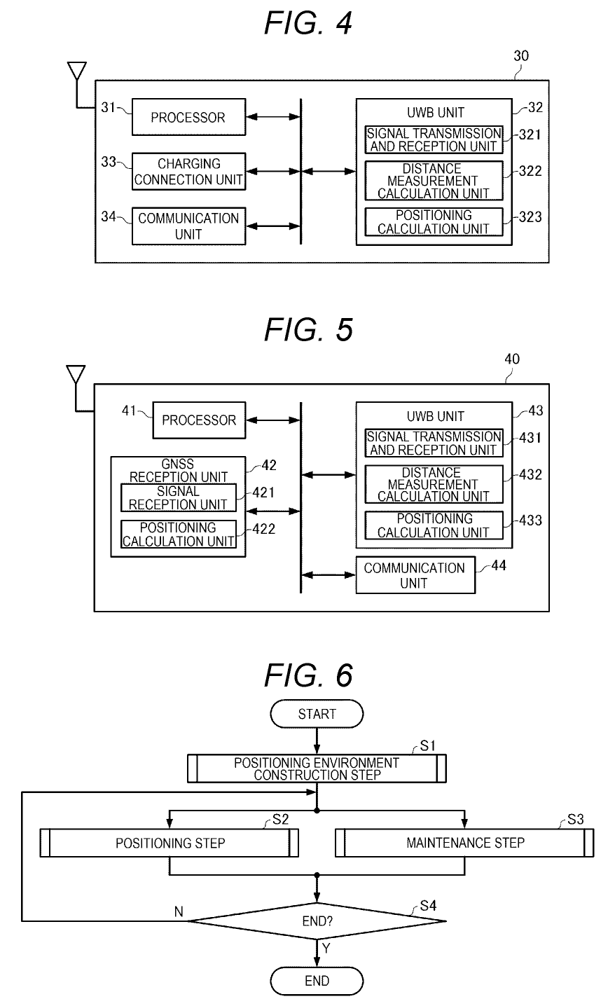

FIG. 4 is a functional block diagram of the charging apparatus 30. As shown in FIG. 4, the charging apparatus 30 includes a processor 31, a UWB unit 32, a charging connection unit 33, and a communication unit 34.

The processor 31 performs control processing on the UWB unit 32, the charging connection unit 33, and the communication unit 34, and various types of calculation processing.

The UWB unit 32 includes a signal transmission and reception unit 321, a distance measurement calculation unit 322, and a positioning calculation unit 323, and performs processing of calculating a position thereof based on a time until a distance measurement signal transmitted to each reference station 10 is returned. The signal transmission and reception unit 321 transmits a predetermined distance measurement signal to each reference station 10 and receives a distance measurement signal returned from each reference station 10. Each reference station 10 receives the distance measurement signal by the signal transmission and reception unit 321 of the UWB unit 32, and returns the distance measurement signal to the charging apparatus 30. The distance measurement calculation unit 322 measures the time until the distance measurement signal transmitted by the signal transmission and reception unit 321 to each reference station 10 is returned, and calculates a distance to each reference station 10 based on the measured time and a propagation speed of the distance measurement signal. The positioning calculation unit 323 calculates a position thereof using a known method such as trilateration based on distances to each of three or more reference stations 10 calculated by the distance measurement calculation unit 322.

The charging connection unit 33 is coupled to the reference station 10 that has flown in and charges the battery 122 of the reference station 10.

The communication unit 34 is an interface for the processor 31 to perform various types of communication with each reference station 10. For example, the processor 31 performs, via the communication unit 34, processing of transmitting various information such as a position thereof and a charging state to each reference station 10.

### 1-5. Functional Configuration of Positioning Target Apparatus

FIG. 5 is a functional block diagram of the positioning target apparatus 40. As shown in FIG. 5, the positioning target apparatus 40 includes a processor 41, a GNSS reception unit 42, a UWB unit 43, and a communication unit 44. UWB is an abbreviation for "Ultra Wide Band".

The processor 41 performs control processing on the GNSS reception unit 42, the UWB unit 43, and the communication unit 44 and various types of calculation processing.

The GNSS reception unit 42 includes a signal reception unit 421 and a positioning calculation unit 422, and performs processing of calculating a position thereof based on a received satellite signal. The signal reception unit 421 receives the satellite signal transmitted from each satellite 2, converts the received GHz-band satellite signal into a MHz-band signal, and further performs amplification processing, filtering processing, A/D conversion processing, and the like. The positioning calculation unit 422 demodulates a navigation message from a digital signal processed and obtained by the signal reception unit 421, and calculates a position thereof using a known method based on various information in the navigation message. The positioning calculation unit 422 generates positioning data including various information such as a position and a reception strength.

The UWB unit 43 includes a signal transmission and reception unit 431, a distance measurement calculation unit 432, and a positioning calculation unit 433, and performs processing of calculating a position thereof based on a time until a distance measurement signal transmitted to each reference station 10 is returned. The signal transmission and reception unit 431 transmits a predetermined distance measurement signal to each reference station 10 and receives a distance measurement signal returned from each reference station 10. Each reference station 10 receives the distance measurement signal by the signal transmission and reception unit 431 of the UWB unit 43, and returns the distance measurement signal to the positioning target apparatus 40. The distance measurement calculation unit 432 measures the time until the distance measurement signal transmitted by the signal transmission and reception unit 431 to each reference station 10 is returned, and calculates a distance to each reference station 10 based on the measured time and a propagation speed of the distance measurement signal. The positioning calculation unit 433 calculates a position thereof using a known method such as trilateration based on distances to each of three or more reference stations 10 calculated by the distance measurement calculation unit 432.

The processor 41 controls whether to cause the GNSS reception unit 42 to calculate a position thereof or cause the UWB unit 43 to calculate the position thereof. For example, the processor 41 causes the UWB unit 43 to calculate the position thereof when the positioning target apparatus 40 is located inside the space AR, and causes the GNSS reception unit 42 to calculate the position thereof when the positioning target apparatus 40 is located outside the space AR.

The communication unit 44 is an interface for the processor 41 to perform various types of communication with each reference station 10. For example, the processor 41 performs, via the communication unit 44, processing of receiving the information on the position of each reference station 10.

### 1-6. Positioning Environment Providing Method

FIG. 6 is a flowchart showing a procedure of a positioning environment providing method using the positioning environment providing system 1. As shown in FIG. 6, first, the positioning environment providing system 1 performs a positioning environment construction step S1 to construct a positioning environment required for the positioning target apparatus 40 to calculate the position thereof in the space AR.

Next, the positioning environment providing system 1 performs, in parallel, a positioning step S2 in which the positioning target apparatus 40 calculates the position thereof and a maintenance step S3 in which charging of each reference station 10, etc., is performed.

Then, in step S4, the positioning environment providing system 1 repeats processing of steps S2 and S3 until the provision of the positioning environment is ended.

Hereinafter, procedures of the positioning environment construction step S1, the positioning step S2, and the maintenance step S3 will be described in order.

### 1-7. Procedure of Positioning Environment Construction Step

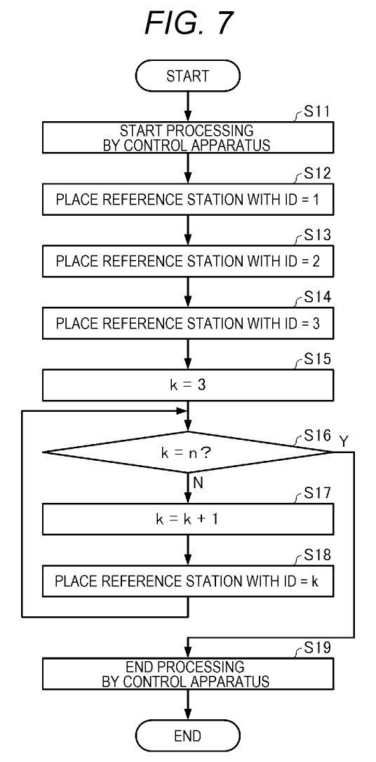

In the positioning environment construction step S1 in FIG. 6, the plurality of reference stations 10 and the control apparatus 20 perform processing. FIG. 7 is a flowchart showing a procedure of the positioning environment construction step S1. As shown in FIG. 7, in the positioning environment construction step S1, the control apparatus 20 detects the reference station 10 and assigns an ID (step S11), places the reference station 10 with ID = 1 (step S12), places the reference station 10 with ID = 2 (step S13), and places the reference station 10 with ID = 3 (step S14). When a number n of the reference stations 10 detected by the control apparatus 20 in step S11 is 3 (steps S15 and S16), end processing (step S19) is performed by the control apparatus 20. When the number n of the reference stations 10 is 4 or more, placement of the reference stations 10 with IDs = 4 to n (steps S16 to S18) and the end processing by the control apparatus 20 (step S19) are further performed.

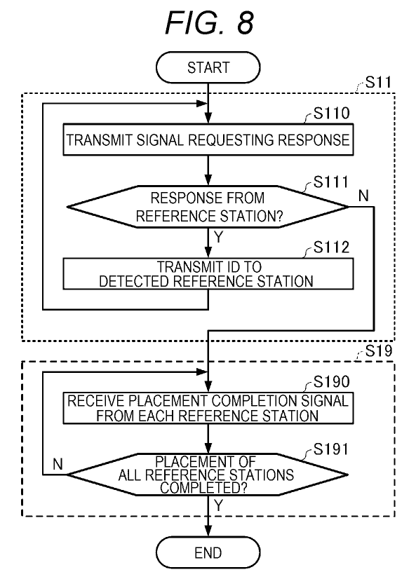

FIG. 8 is a flowchart showing a processing procedure of steps S11 and S19 in FIG. 7 by the control apparatus 20. As shown in FIG. 8, step S11 includes steps S110, S111, and S112, and step S19 includes steps S190 and S191. As shown in FIG. 8, first, the control apparatus 20 transmits a signal requesting a response (step S110). When there is a response from any of the reference stations 10 (Y in step S111), the control apparatus 20 transmits an ID to the detected reference station 10 (step S112). The control apparatus 20 repeats the processing of steps S110 to S112 until there is no response from any reference station 10. In step S112, the control apparatus 20 transmits sequential IDs to each detected reference station 10 in order from ID = 1.

When there is no response from any of the reference stations 10 (N in step S111), the control apparatus 20 then receives a placement completion signal from each of the reference stations 10 (step S190), and when placement of all the reference stations 10 is completed (Y in step S191), the processing is ended.

By the processing of steps S11 and S19 by the control apparatus 20, IDs = 1 to n are assigned to the n reference stations 10, respectively. Hereinafter, it is assumed that ID = 1 is assigned to the reference station 10a, ID = 2 is assigned to the reference station 10b, ID = 3 is assigned to the reference station 10c, ID = 4 is assigned to the reference station 10d, ID = 5 is assigned to the reference station 10e, and ID = 6 is assigned to the reference station 10f shown in FIG. 1.

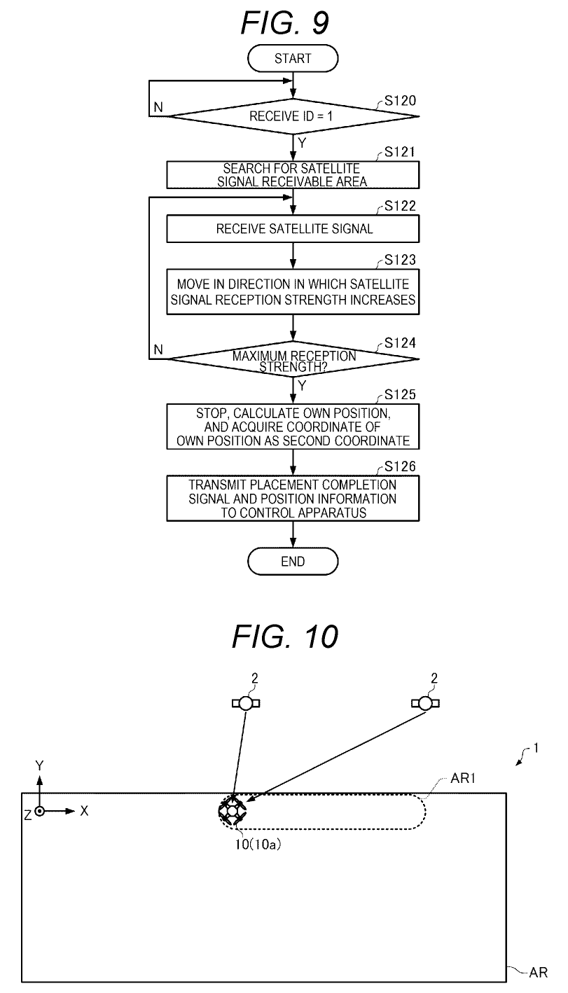

FIG. 9 is a flowchart showing a processing procedure of step S12 in FIG. 7 by the reference station 10a to which ID = 1 is assigned. As shown in FIG. 9, first, the reference station 10a stands by until ID = 1 is received (N in step S120) and searches, when ID = 1 is received (Y in step S120), for a satellite signal receivable area in the space AR (step S121). By receiving ID = 1, ID = 1 is assigned to the reference station 10a, and thereafter, communication with the reference station 10a is performed using ID = 1.

Next, the reference station 10a receives the satellite signal (step S122) and moves in a direction in which a satellite signal reception strength increases (step S123). The reference station 10a repeats the processing of steps S122 and S123 until the satellite signal reception strength is maximized (N in step S124), stops when the satellite signal reception strength is maximized (Y in step S124), calculates a position thereof, and acquires a coordinate of the position thereof as a first coordinate (step S125). The reference station 10a may stop in the air while rotating the blade 123, and it is preferable to land on a floor, a shelf, or the like and stop in order to reduce consumption of the battery 122.

Finally, the reference station 10a transmits position information including the placement completion signal and the first coordinate to the control apparatus 20 (step S126), and ends the processing. FIG. 10 shows a state in which the placement of the reference station 10a is completed. In FIG. 10, AR1 indicates a satellite signal receivable area.

In this way, the reference station 10a receives the satellite signal transmitted from each satellite 2, specifies a position where the satellite signal reception strength is equal to or greater than a predetermined value as the position thereof in the predetermined space AR, and acquires the coordinate indicating the specified position as the first coordinate. In general, as the reception strength of the reference station 10a increases, positioning accuracy of the positioning target apparatus 40 increases. The predetermined value is determined according to a specification and an environment of the positioning environment providing system 1, and may be, for example, a minimum value of the reception strength required for satellite signal positioning of the reference station 10a. Since the stop position of the reference station 10a is the position where the reception strength is maximized, the stop position is a position where the reception strength is equal to or greater than the predetermined value. The stop position of the reference station 10a may be a position where the reception strength is equal to or greater than the predetermined value, and may not be the position where the reception strength is maximized.

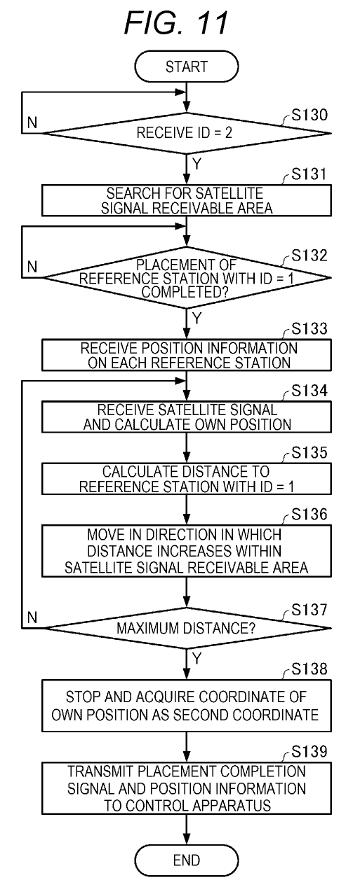

FIG. 11 is a flowchart showing a processing procedure of step S13 in FIG. 7 by the reference station 10b to which ID = 2 is assigned. As shown in FIG. 11, first, the reference station 10b stands by until ID = 2 is received (N in step S130) and searches, when ID = 2 is received (Y in step S130), for the satellite signal receivable area in the space AR (step S131). The reference station 10b may efficiently search for the receivable area in cooperation with each reference station 10. By receiving ID = 2, ID = 2 is assigned to the reference station 10b, and thereafter, communication with the reference station 10b is performed using ID = 2.

Next, the reference station 10b stands by until the placement of the reference station 10a with ID = 1 is completed (N in step S132), and when the placement of the reference station 10a is completed (Y in step S132), receives the position information on each reference station 10 (step S133). That is, after the reference station 10a acquires the first coordinate indicating the position thereof, the reference station 10b performs processing of step S133 and subsequent steps.

Next, the reference station 10b receives the satellite signal and calculates a position thereof (step S134), and calculates a distance L to the reference station 10a with ID = 1 based on the position of the reference station 10a received in step S133 and the position thereof calculated in step S134 (step S135).

Next, the reference station 10b moves in a direction in which the distance L from the reference station 10a increases within the satellite signal receivable area (step S136). The reference station 10b repeats the processing of steps S135 and S136 until the distance L to the reference station 10a is maximized (N in step S137). When the distance L to the reference station 10a is maximized (Y in step S137), the reference station 10b stops and acquires a coordinate of the position thereof as a second coordinate (step S138). The reference station 10b may stop in the air while rotating the blade 123, and it is preferable to land on a floor, a shelf, or the like and stop in order to reduce consumption of the battery 122.

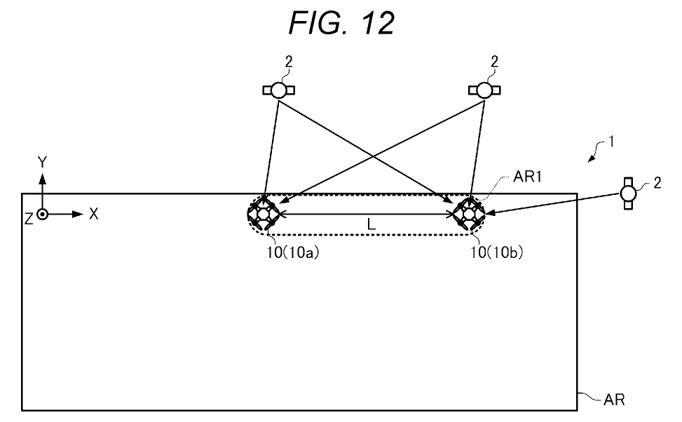

Finally, the reference station 10b transmits position information including the placement completion signal and the second coordinate to the control apparatus 20 (step S139), and ends the processing. FIG. 12 shows a state in which the placement of the reference station 10b is completed. In FIG. 12, AR1 indicates a satellite signal receivable area.

In this way, the reference station 10b receives the satellite signal transmitted from each satellite 2, autonomously moves in the predetermined space AR after the reference station 10a acquires the first coordinate, communicates with the reference station 10a to acquire the first coordinate, measures the distance L from the position of the reference station 10a indicated by the first coordinate to the position thereof, specifies, in the satellite signal receivable area in the predetermined space AR, the position thereof where the distance L is equal to or greater than a predetermined value, and acquires the coordinate indicating the specified position as the second coordinate. In general, as the distance L between the reference station 10a and the reference station 10b increases, the positioning accuracy of the positioning target apparatus 40 increases. The predetermined value is determined according to the specification and the environment of the positioning environment providing system 1, and may be, for example, a value that satisfies required positioning accuracy. Since the stop position of the reference station 10b is a position where the distance L is maximized, the stop position is a position where the distance L is equal to or greater than the predetermined value. The stop position of the reference station 10b may be a position where the distance L is equal to or greater than the predetermined value, and may not be the position where the distance L is maximized.

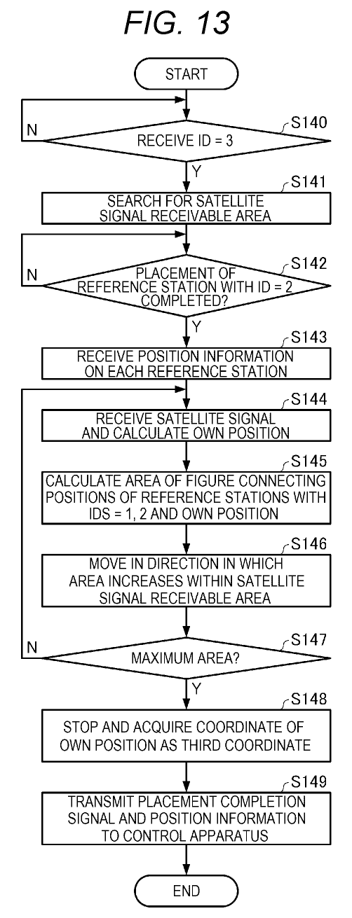

FIG. 13 is a flowchart showing a processing procedure of step S14 in FIG. 7 by the reference station 10c to which ID = 3 is assigned. As shown in FIG. 13, first, the reference station 10c stands by until ID = 3 is received (N in step S140) and searches, when ID = 3 is received (Y in step S140), for the satellite signal receivable area in the space AR (step S141). The reference station 10c may efficiently search for the receivable area in cooperation with each reference station 10. By receiving ID = 3, ID = 3 is assigned to the reference station 10c, and thereafter, communication with the reference station 10c is performed using ID = 3.

Next, the reference station 10c stands by until the placement of the reference station 10b with ID = 2 is completed (N in step S142), and when the placement of the reference station 10b is completed (Y in step S142), receives the position information on each reference station 10 (step S143). That is, after the reference station 10b acquires the second coordinate indicating the position thereof, the reference station 10c performs processing of step S143 and subsequent steps.

Next, the reference station 10c receives the satellite signal and calculates a position thereof (step S144), and calculates an area S of a figure connecting each position of the reference stations 10a and 10b with IDs = 1, 2 received in step S143 and the position thereof calculated in step S144 (step S145).

Next, the reference station 10c moves in a direction in which the area S increases within the satellite signal receivable area (step S146). The reference station 10c repeats the processing of steps S145 and S146 until the area S is maximized (N in step S147). When the area S is maximized (Y in step S147), the reference station 10c stops and acquires a coordinate of the position thereof as a third coordinate (step S148). The reference station 10c may stop in the air while rotating the blade 123, and it is preferable to land on a floor, a shelf, or the like and stop in order to reduce consumption of the battery 122.

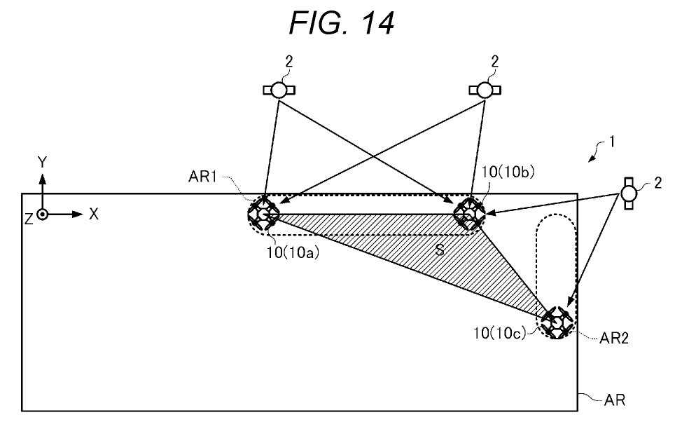

Finally, the reference station 10c transmits position information including the placement completion signal and the third coordinate to the control apparatus 20 (step S149), and ends the processing. FIG. 14 shows a state in which the placement of the reference station 10c is completed. In FIG. 14, AR1 and AR2 indicate satellite signal receivable areas.

In this way, the reference station 10c receives the satellite signal transmitted from each satellite 2, autonomously moves in the predetermined space AR after the reference station 10b acquires the second coordinate, communicates with each of the reference stations 10a and 10b to acquire the first coordinate and the second coordinate, specifies, in the satellite signal receivable area in the predetermined space AR, the position thereof where the area S of a triangle, which is a figure connecting the position of the reference station 10a indicated by the first coordinate, the position of the reference station 10b indicated by the second coordinate, and the position thereof, is equal to or greater than the predetermined value, and acquires the coordinate indicating the specified position as the third coordinate. In general, as the area S of the figure connecting the positions of the reference stations 10a, 10b, and 10c increases, the positioning accuracy of the positioning target apparatus 40 tends to increase. The predetermined value is determined according to the specification and the environment of the positioning environment providing system 1, and may be, for example, a value that satisfies required positioning accuracy. Since the stop position of the reference station 10c is a position where the area S is maximized, the stop position is a position where the area S is equal to or greater than the predetermined value. The stop position of the reference station 10c may be a position where the area S is equal to or greater than the predetermined value, and may not be the position where the area S is maximized.

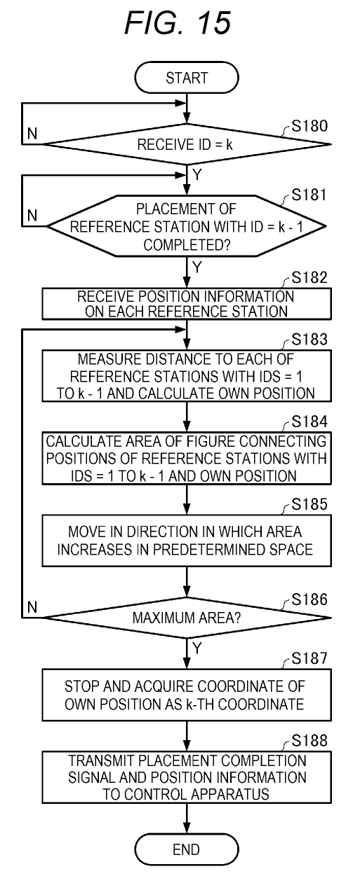

FIG. 15 is a flowchart showing a processing procedure of step S18 in FIG. 7 by the reference station 10 to which ID = k is assigned. Here, k is any integer of 4 or more. As shown in FIG. 15, first, the reference station 10 stands by until ID = k is received (N in step S180) and stands by, when ID = k is received (Y in step S180), until placement of the reference station 10 with ID = k - 1 is completed (N in step S181). By receiving ID = k, ID = k is assigned to the reference station 10, and thereafter, communication with the reference station 10 is performed using ID = k.

Next, when the placement of the reference station 10 with ID = k - 1 is completed (Y in step S181), the reference station 10 with ID = k receives the position information on each reference station 10 (step S182). That is, after the reference station 10 with ID = k - 1 acquires a (k - 1)-th coordinate indicating a position thereof, the reference station 10 with ID = k performs processing of step S182 and subsequent steps.

Next, the reference station 10 with ID = k measures a distance to each of the reference stations 10 with IDs = 1 to k - 1 and calculates a position thereof (step S183). Specifically, the reference station 10 with ID = k transmits a predetermined distance measurement signal to each of the reference stations 10 with IDs = 1 to k - 1, and measures the distance to each reference station 10 based on a time until the distance measurement signal transmitted to each reference station 10 is returned. Then, the reference station 10 with ID = k calculates the position thereof based on each position of the reference stations 10 with IDs = 1 to k - 1 received in step S182 and the measured distance to each reference station 10.

Next, the reference station 10 with ID = k calculates the area S of a figure connecting each position of the reference stations 10 with IDs = 1 to k - 1 received in step S182 and the position thereof calculated in step S183 (step S184).

Next, the reference station 10 with ID = k moves in a direction in which the area S increases in the predetermined space AR (step S185). The reference station 10 with ID = k repeats the processing of steps S183 to S185 until the area S is maximized (N in step S186). The reference stations 10 with IDs = 1 to k - 1 may be stopped, or at least one of the reference stations 10 with IDs = 1 to k - 1 may move to increase the area S.

When the area S is maximized (Y in step S186), the reference station 10 with ID = k stops and acquires a coordinate of the position thereof as a k-th coordinate (step S187). The reference station 10 with ID = k may stop in the air while rotating the blade 123, and it is preferable to land on a floor, a shelf, or the like and stop in order to reduce consumption of the battery 122.

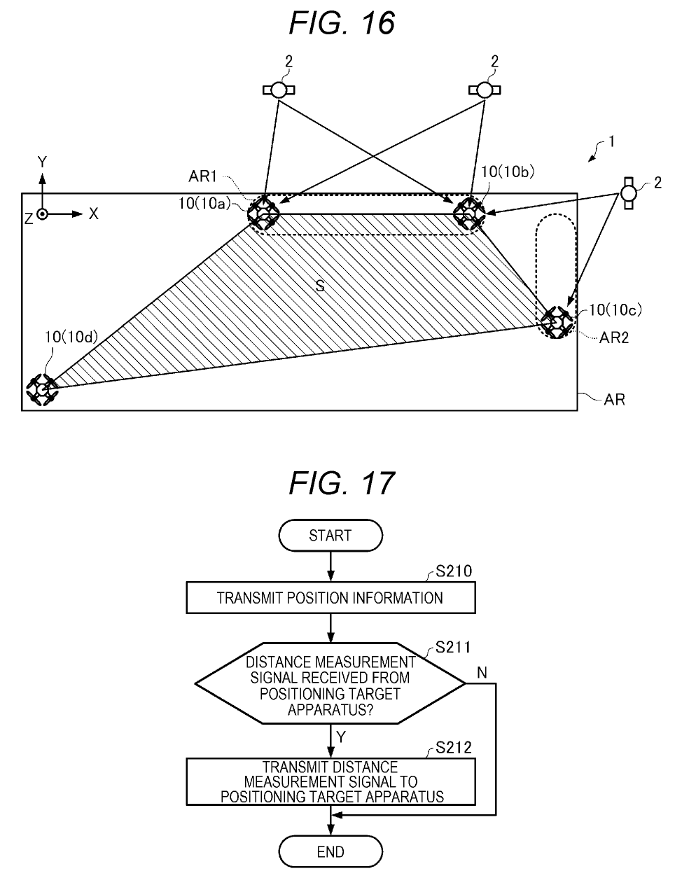

Finally, the reference station 10 with ID = k transmits position information including the placement completion signal and the k-th coordinate to the control apparatus 20 (step S188), and ends the processing. FIG. 16 shows a state in which placement of the reference station 10d with ID = 4 is completed. In FIG. 16, AR1 and AR2 indicate satellite signal receivable areas.

For example, the reference station 10d with ID = 4 communicates with each of the reference stations 10a, 10b, and 10c with IDs = 1, 2, 3 to acquire the first coordinate, the second coordinate, and the third coordinate, measures a first distance from the position of the reference station 10a indicated by the first coordinate to a position thereof, a second distance from the position of the reference station 10b indicated by the second coordinate to the position thereof, and a third distance from the position of the reference station 10c indicated by the third coordinate to the position thereof, and acquires a fourth coordinate indicating the position thereof based on the first coordinate, the second coordinate, the third coordinate, the first distance, the second distance, and the third distance. Specifically, the reference station 10d autonomously moves in the predetermined space AR after the reference station 10c acquires the third coordinate, communicates with each of the reference stations 10a, 10b, and 10c to acquire the first coordinate, the second coordinate, and the third coordinate, specifies, in the predetermined space AR, the position thereof where the area S of a quadrangle that is a figure connecting the position of the reference station 10a indicated by the first coordinate, the position of the reference station 10b indicated by the second coordinate, the position of the reference station 10c indicated by the third coordinate, and the position thereof is equal to or greater than a predetermined value, and acquires the coordinate indicating the specified position as the fourth coordinate. In general, as the area S of the figure connecting the positions of the reference stations 10a, 10b, 10c, and 10d increases, the positioning accuracy of the positioning target apparatus 40 tends to increase. The predetermined value is determined according to the specification and the environment of the positioning environment providing system 1, and may be, for example, a value that satisfies required positioning accuracy. Since the stop position of the reference station 10d is a position where the area S is maximized, the stop position is a position where the area S is equal to or greater than the predetermined value. The stop position of the reference station 10d may be a position where the area S is equal to or greater than the predetermined value, and may not be the position where the area S is maximized.

### 1-8. Procedure of Positioning Step

In the positioning step S2 in FIG. 6, each of the reference stations 10 with IDs = 1 to n and the positioning target apparatus 40 perform processing. FIG. 17 is a flowchart showing a processing procedure of each reference station 10 in the positioning step S2. As shown in FIG. 17, first, each reference station 10 transmits the position information including the coordinate of the position thereof (step S210).

Next, when the distance measurement signal is received from the positioning target apparatus 40 (Y in step S211), each reference station 10 transmits the distance measurement signal to the positioning target apparatus 40 (step S212). When the distance measurement signal is not received from the positioning target apparatus 40 (N in step S211), each reference station 10 does not perform the processing of step S212.

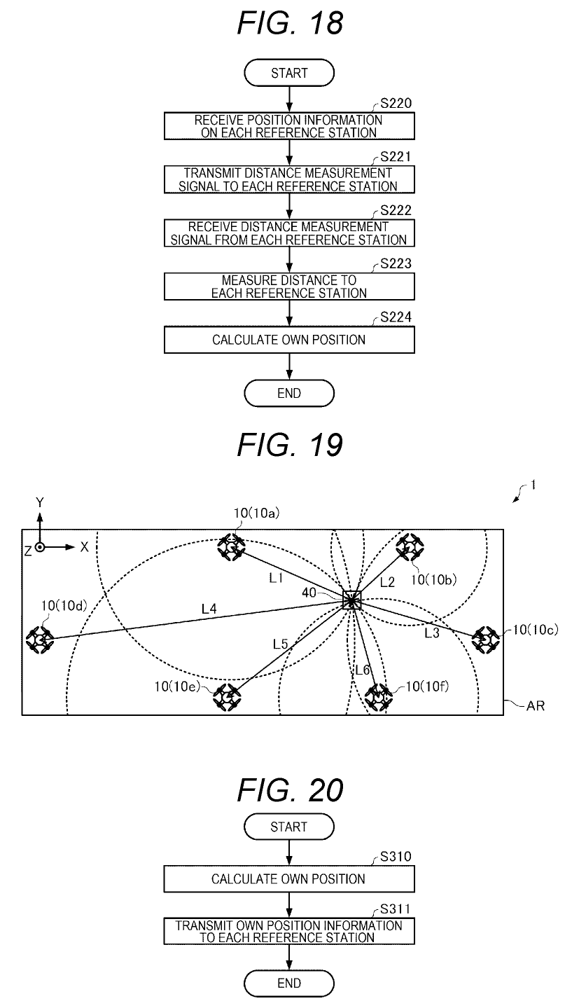

FIG. 18 is a flowchart showing a processing procedure of the positioning target apparatus 40 in the positioning step S2. As shown in FIG. 18, first, the positioning target apparatus 40 receives the position information transmitted by each reference station 10 with IDs = 1 to n in step S210 in FIG. 17 (step S220).

Next, the positioning target apparatus 40 transmits the distance measurement signal to each reference station 10 (step S221) and receives the distance measurement signal transmitted by each reference station 10 in step S212 in FIG. 17 (step S222).

Next, the positioning target apparatus 40 measures distances L1 to Ln to the reference stations 10 with IDs = 1 to n based on a time until the distance measurement signal transmitted in step S221 returns in step S222 (step S223).

The positioning target apparatus 40 calculates the position thereof based on the position of each reference station 10 received in step S220 and the distances L1 to Ln measured in step S223 (step S224). The positioning target apparatus 40 is not required to use all of the positions of the n reference stations 10 and the n distances L1 to Ln to calculate the position thereof, and may use positions and distances of any three or more reference stations 10. FIG. 19 shows a state during the positioning of the positioning target apparatus 40. In FIG. 19, a broken line indicates a part of a circle centered on the position of each reference station 10.

As shown in FIG. 6, since the positioning step S2 is repeated until the provision of the positioning environment is ended, each reference station 10 repeats the processing of steps S210 to S212 in FIG. 17, and the positioning target apparatus 40 repeats the processing of steps S220 to S224 in FIG. 18 to calculate the position thereof in a time series.

### 1-9. Procedure of Maintenance Step

In the maintenance step S3 in FIG. 6, each of the reference stations 10 with IDs = 1 to n, the charging apparatus 30, and the exchange device 50 performs processing. FIG. 20 is a flowchart showing a processing procedure of the charging apparatus 30 in the maintenance step S3. As shown in FIG. 20, the charging apparatus 30 calculates a position including a coordinate of the position thereof (step S310). For example, the charging apparatus 30 may receive the position information on each reference station 10, measure a distance to each reference station 10 based on a time until the distance measurement signal transmitted to each reference station 10 is returned, and calculate the position thereof based on the received position of each reference station 10 and the measured distance to each reference station 10.

The charging apparatus 30 transmits position information thereof to each reference station 10 (step S311). When the position is fixed, the charging apparatus 30 may transmit known position information to each reference station 10 in step S311 without performing the processing of step S310.

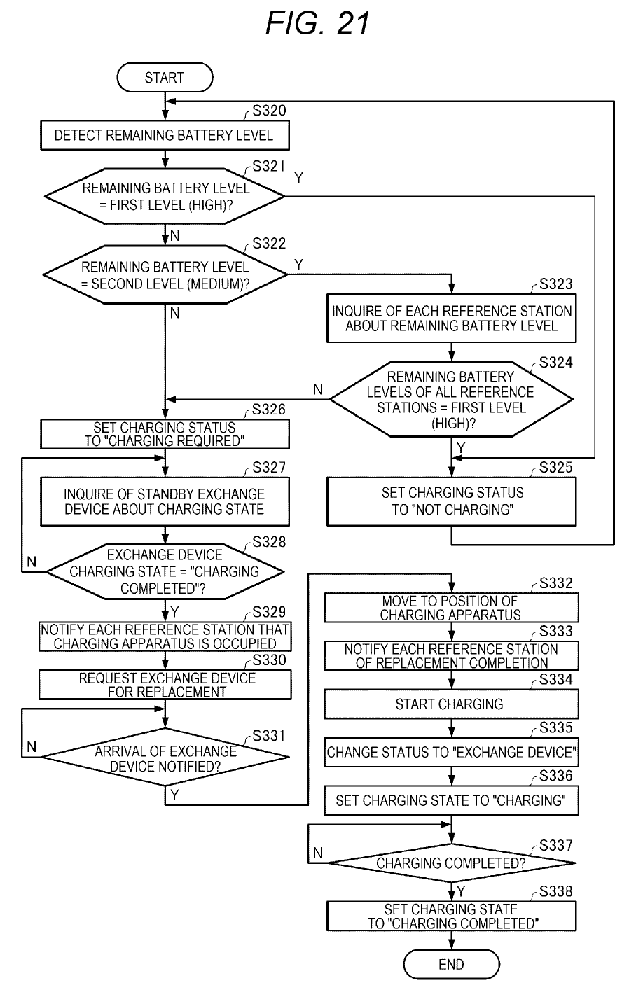

FIG. 21 is a flowchart showing a processing procedure of the reference station 10 with ID = m in the maintenance step S3. Here, m is any integer of 1 or more and n or less. As shown in FIG. 21, first, the reference station 10 with ID = m detects a remaining level of the battery 122 thereof (step S320). In the embodiment, the remaining level of the battery 122 is classified into one of a first level, a second level, and a third level, and the reference station 10 with ID = m detects whether the remaining level of the battery 122 is the first level, the second level, or the third level. The first level means that the remaining level of the battery 122 is relatively high. The second level is lower than the first level and means that the remaining level of the battery 122 is medium. The third level is lower than the second level and means that the remaining level of the battery 122 is relatively low.

When the remaining level of the battery 122 thereof is the third level (N in step S321 and N in step S322), the reference station 10 with ID = m sets a charging status to "charging required" (step S326).

When the remaining level of the battery 122 thereof is the second level (N in step S321 and Y in step S322), the reference station 10 with ID = m inquires of each reference station 10 about the remaining level of the battery 122. Then, when the remaining level of the battery 122 of at least one reference station 10 is not the first level (N in step S324), the reference station 10 with ID = m sets the charging status to "charging required" (step S326), when remaining levels of batteries 122 of all the reference stations 10 are the first level (Y in step S324), sets the charging status to "not charging" (step S325), and performs processing of step S320 and subsequent steps again. In addition, when the remaining level of the battery 122 thereof is the first level (Y in step S321), the reference station 10 with ID = m sets the charging status to "not charging" without performing the processing of steps S323 and S324 (step S325), and performs the processing of step S320 and subsequent steps again.

When the charging status is set to "charging required" (step S326), the reference station 10 with ID = m inquires of the standby exchange device 50 about a charging state (step S327). When the charging state of the exchange device 50 is not "charging completed", that is, is "charging" (N in step S328), the reference station 10 with ID = m repeats the processing of step S327 until "charging completed". When the charging state of the exchange device 50 is "charging completed" (Y in step S328), the reference station 10 with ID = m notifies each reference station 10 that the charging apparatus 30 is occupied (step S329) and requests the exchange device 50 to perform replacement (step S330).

Next, the reference station 10 with ID = m stands by until a notification indicating that the exchange device 50 has arrived at a position thereof is received (N in step S331), and moves to the position of the charging apparatus 30 (step S332) upon receiving the arrival notification (Y in step S331).

Next, the reference station 10 with ID = m notifies each reference station 10 of completion of replacement with the exchange device 50 (step S333), and starts charging (step S334).

Next, the reference station 10 with ID = m changes a status thereof to "exchange device" (step S335) and sets the charging state to "charging" (step S336). Accordingly, the reference station 10 with ID = m becomes the exchange device 50 and enters a standby state.

The exchange device 50 stands by until the charging is completed (N in step S337), and when the charging is completed (Y in step S337), sets the charging state to "charging completed" (step S338).

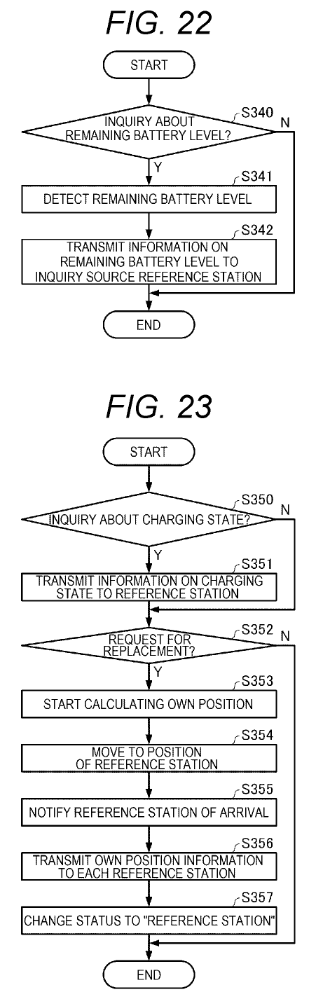

FIG. 22 is a flowchart showing a processing procedure of the reference station 10 with ID ≠ m in the maintenance step S3. As shown in FIG. 22, when there is an inquiry about the remaining level of the battery 122 from the reference station 10 with ID = m (Y in step S340), the reference station 10 with ID ≠ m detects the remaining level of the battery 122 (step S341). That is, the reference station 10 with ID ≠ m detects whether the remaining level of the battery 122 is the first level, the second level, or the third level.

The reference station 10 with ID ≠ m transmits information on the remaining level of the battery 122 to the reference station 10 with ID = m that is a source of the inquiry (step S342).

FIG. 23 is a flowchart showing a processing procedure of the exchange device 50 in the maintenance step S3. As shown in FIG. 23, when there is an inquiry about the charging state from the reference station 10 with ID = m (Y in step S350), the exchange device 50 transmits information on the charging state to the reference station 10 with ID = m (step S351). That is, the exchange device 50 transmits information indicating whether the charging state is "charging" or "charging completed" to the reference station 10 with ID = m. When there is no inquiry about the charging state from the reference station 10 with ID = m (N in step S350), the exchange device 50 does not perform processing of step S351.

When there is a request for replacement from the reference station 10 with ID = m (Y in step S352), the exchange device 50 starts calculating a position thereof (step S353) and moves to the position of the reference station 10 with ID = m (step S354).

Next, when a difference between the position thereof and the position of the reference station 10 with ID = m approaches zero, the exchange device 50 notifies the reference station 10 with ID = m of arrival (step S355), transmits position information thereof to each reference station 10 (step S356), and changes a status thereof to "reference station". The exchange device 50 that has become the reference station 10 takes over ID = m, and subsequent communication is performed using ID = m.

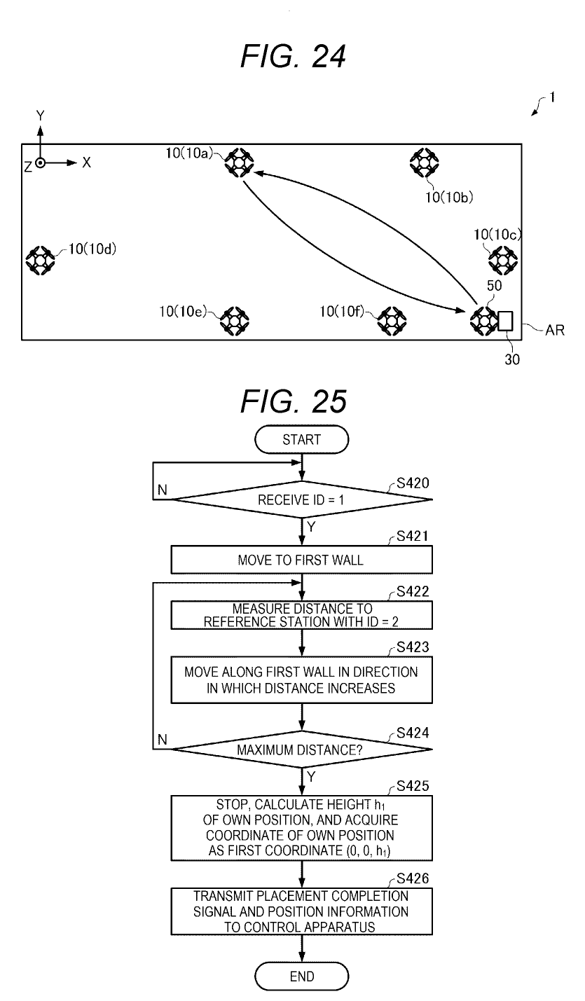

For example, when m = 1, as shown in FIG. 24, the reference station 10a with ID = 1 is replaced with the exchange device 50. That is, the reference station 10a with ID = 1 calculates a remaining battery level thereof and communicates with the exchange device 50 based on the remaining battery level thereof, and the exchange device 50 moves to the position of the reference station 10a indicated by the first coordinate. A remaining battery level of the exchange device 50 is equal to or greater than a predetermined value, and the reference station 10a moves to a position where electric power can be supplied from the charging apparatus 30. For example, the predetermined value may be equal to or greater than a lower limit value of the first level. Meanwhile, each of the reference stations 10b to 10f with IDs = 2 to 6 calculates a remaining battery level thereof in response to an inquiry from the reference station 10a. Then, the reference station 10a acquires information on the remaining battery level from each of the reference stations 10b to 10f, and does not move when the remaining battery level thereof is the first level, and moves to the position where the electric power can be supplied from the charging apparatus 30 when the remaining battery level thereof is the second level and the remaining battery level of any one of the reference stations 10b to 10f is the second level or the third level, or when the remaining battery level thereof is the third level. That is, when the remaining battery level of any one of the reference stations 10b to 10f is the second level or the third level, the charging apparatus 30 may be immediately occupied by any one of the reference stations 10b to 10f, and thus the reference station 10a quickly moves to the position where the electric power can be supplied from the charging apparatus 30. On the other hand, when the remaining battery level of the reference station 10a is the second level and all remaining battery levels of the reference stations 10b to 10f are the first level, the remaining battery level of the reference station 10a is not likely to immediately become zero, the charging apparatus 30 is not likely to be immediately occupied by the reference stations 10b to 10f, and thus the reference station 10a does not move.

The reference station 10a is an example of a "first reference station", the reference station 10b is an example of a "second reference station", the reference station 10c is an example of a "third reference station", and the reference station 10d is an example of a "fourth reference station".

### 1-10. Effects and Advantages

As described above, in the positioning environment providing system 1 of the first embodiment, each reference station 10 is autonomously movable in the predetermined space AR, the reference station 10a acquires the first coordinate indicating the position thereof, the reference station 10b communicates with the reference station 10a and acquires the second coordinate indicating the position thereof based on the first coordinate, and the reference station 10c communicates with the reference stations 10a and 10b and acquires the third coordinate indicating the position thereof based on the first coordinate and the second coordinate. In this way, according to the positioning environment providing system 1 of the first embodiment, since each of the reference stations 10a, 10b, and 10c autonomously moves in the predetermined space AR and acquires the first coordinate, the second coordinate, and the third coordinate indicating the positions thereof, it is possible to reduce man-hours required to provide the positioning environment.

According to the positioning environment providing system 1 of the first embodiment, since the reference station 10a receives the satellite signal transmitted from the satellite 2 and specifies the position where the satellite signal reception strength is equal to or greater than the predetermined value as the position thereof in the space AR, it is possible to acquire the first coordinate with high accuracy, and thus it is possible to provide the positioning environment with high accuracy.

According to the positioning environment providing system 1 of the first embodiment, since the reference station 10b specifies, in the satellite signal receivable area, the position thereof where the distance from the position indicated by the first coordinate to the position thereof is equal to or greater than the predetermined value and thus the reference stations 10a and 10b are placed apart from each other, a difference between the first coordinate and the second coordinate increases, and it is possible to provide the positioning environment with high accuracy.

According to the positioning environment providing system 1 of the first embodiment, since the reference station 10c specifies, in the satellite signal receivable area, the position thereof where the area of the figure connecting the positions indicated by the first coordinate and the second coordinate and the position thereof is equal to or greater than the predetermined value and thus the reference stations 10a, 10b, and 10c are placed apart from each other, a difference among the first coordinate, the second coordinate, and the third coordinate increases, and it is possible to provide the positioning environment with high accuracy.

According to the positioning environment providing system 1 of the first embodiment, the reference station 10d autonomously moves in the space AR and acquires the fourth coordinate indicating the position thereof based on the positions of the reference stations 10a, 10b, and 10c, and thus it is possible to provide the positioning environment with high accuracy based on the first coordinate, the second coordinate, the third coordinate, and the fourth coordinate. In particular, since the reference station 10d specifies the position thereof where the area of the figure connecting the positions indicated by the first coordinate, the second coordinate, and the third coordinate and the position thereof is equal to or greater than the predetermined value and thus the reference stations 10a, 10b, 10c, and 10d are placed apart from each other, a difference among the first coordinate, the second coordinate, the third coordinate, the fourth coordinate increases, and it is possible to provide the positioning environment with high accuracy.

According to the positioning environment providing system 1 of the first embodiment, each reference station 10 can autonomously move based on the remaining level of the battery 122 thereof and charge the battery 122 by being replaced with the exchange device 50 whose battery 122 is sufficiently charged. For example, when the remaining level of the battery 122 of the reference station 10a is high, the reference station 10a is not replaced with the exchange device 50, when the remaining level of the battery 122 of the reference station 10a is low, the reference station 10a is replaced with the exchange device 50 and charged, and when the remaining level of the battery 122 of the reference station 10a is medium, if the remaining level of the battery 122 of any of the reference stations 10b to 10f is not high, the reference station 10a can be replaced with the exchange device 50 and charged before the charging apparatus 30 is occupied by any of the reference stations 10b to 10f.

### 2. Second Embodiment

Hereinafter, in a second embodiment, the same elements as those in the first embodiment will be denoted by the same reference signs, repetitive description as that in the first embodiment will be omitted or simplified, and contents different from those in the first embodiment will be mainly described.

Since an overview of the positioning environment providing system 1 of the second embodiment is the same as that in FIG. 1, illustration and description thereof will be omitted. In addition, in the positioning environment providing system 1 of the second embodiment, configurations of the reference station 10, the control apparatus 20, the charging apparatus 30, and the positioning target apparatus 40 are the same as those in FIGS. 2 to 5, a configuration of the exchange device 50 is the same as that in FIG. 2, and thus description thereof will be omitted. However, in the second embodiment, each reference station 10 calculates the position thereof without using the satellite signal. Therefore, each reference station 10 may not include the GNSS reception unit 13. The positioning environment providing system 1 of the second embodiment can provide an environment for measuring the position of the positioning target apparatus 40 even when the predetermined space AR is a space where a satellite signal radio wave cannot reach.

A flowchart showing a procedure of a positioning environment providing method by the positioning environment providing system 1 of the second embodiment is the same as FIG. 6, and thus illustration and description thereof will be omitted. In addition, in the second embodiment, since a flowchart showing the procedure of the positioning environment construction step S1 in FIG. 6 is the same as FIG. 7, illustration and description thereof will be omitted. In addition, in the second embodiment, a flowchart showing the processing procedure of steps S11 and S19 in FIG. 7 by the control apparatus 20 is the same as that in FIG. 8, and thus illustration and description thereof will be omitted.

FIG. 25 is a flowchart showing a processing procedure of step S12 in FIG. 7 by the reference station 10a to which ID = 1 is assigned in the second embodiment. As shown in FIG. 25, first, the reference station 10a stands by until ID = 1 is received (N in step S420), and moves, when ID = 1 is received (Y in step S420), to a first wall W1 in the space AR. For example, the reference station 10a stands by in the vicinity of a center of the space AR and moves from a standby position toward the first wall W1. The standby position of the reference station 10a may not be in the vicinity of the center of the space AR, and any position in the space AR can be set as the standby position. By receiving ID = 1, ID = 1 is assigned to the reference station 10a, and thereafter, communication with the reference station 10a is performed using ID = 1.

Next, the reference station 10a measures a distance to the reference station 10b with ID = 2 (step S422), and moves along the first wall W1 in a direction in which the distance to the reference station 10b increases (step S423). The reference station 10a repeats processing of steps S422 and S423 until the distance to the reference station 10b is maximized (N in step S424). Then, when the distance to the reference station 10b is maximized (Y in step S424), the reference station 10a stops, calculates a height h₁ thereof, and acquires a coordinate of a position thereof as the first coordinate (0, 0, h₁) (step S425). For example, the reference station 10a measures, using the proximity sensor 16, a distance to an object vertically below such as a floor or a shelf, and calculates the height h₁. The reference station 10a may stop in the air while rotating the blade 123, and it is preferable to land on a floor, a shelf, or the like and stop in order to reduce consumption of the battery 122.

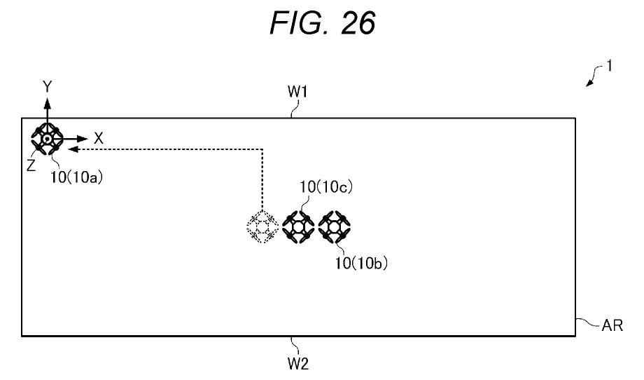

Finally, the reference station 10a transmits position information including the placement completion signal and the first coordinate to the control apparatus 20 (step S426), and ends the processing. FIG. 26 shows a state in which the placement of the reference station 10a is completed. In FIG. 26, a dashed arrow indicates a movement path of the reference station 10a.

In this way, the reference station 10a moves along the first wall W1, specifies a position along the first wall W1 as the position thereof, and acquires the coordinate indicating the specified position as the first coordinate.

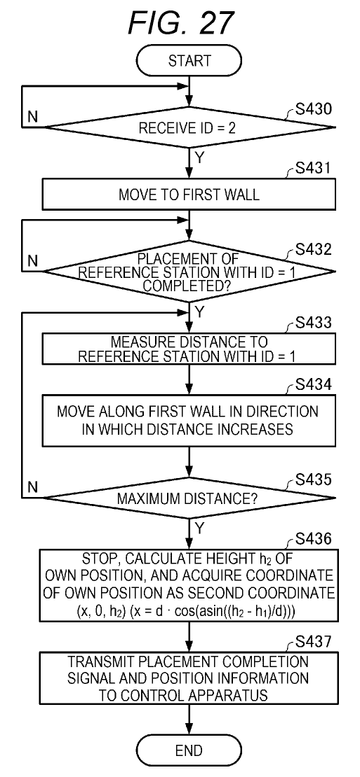

FIG. 27 is a flowchart showing a processing procedure of step S13 in FIG. 7 by the reference station 10b to which ID = 2 is assigned in the second embodiment. As shown in FIG. 27, first, the reference station 10b stands by until ID = 2 is received (N in step S430), and moves, when ID = 2 is received (Y in step S430), to the first wall W1 in the space AR. For example, the reference station 10b stands by in the vicinity of the center of the space AR and moves from a standby position toward the first wall W1. The standby position of the reference station 10b may not be in the vicinity of the center of the space AR, and any position in the space AR can be set as the standby position. By receiving ID = 2, ID = 2 is assigned to the reference station 10b, and thereafter, communication with the reference station 10b is performed using ID = 2.

Next, the reference station 10b stands by until the placement of the reference station 10a with ID = 1 is completed (N in step S432), and when the placement of the reference station 10a is completed (Y in step S432), a distance d to the reference station 10a with ID = 1 is measured (step S433). Specifically, the reference station 10b transmits a predetermined distance measurement signal to the reference station 10a, and measures the distance d to the reference station 10a based on a time until the distance measurement signal transmitted to the reference station 10a is returned. Then, the reference station 10b moves along the first wall W1 in a direction in which the distance d to the reference station 10a increases (step S434). That is, the reference station 10b moves along the first wall W1 in a direction opposite to the reference station 10a.

The reference station 10b repeats the processing of steps S433 and S434 until the distance d to the reference station 10a is maximized (N in step S435). Then, when the distance d to the reference station 10a is maximized (Y in step S435), the reference station 10b stops, calculates a height h₂ thereof, and acquires a coordinate of a position thereof as the second coordinate (x, 0, h₂) (step S436). Here, x = d · cos(asin((h₂ - h₁)/d)). For example, the reference station 10b measures, using the proximity sensor 16, a distance to an object vertically below such as a floor or a shelf, and calculates the height h₂. The reference station 10b may stop in the air while rotating the blade 123, and it is preferable to land on a floor, a shelf, or the like and stop in order to reduce consumption of the battery 122.

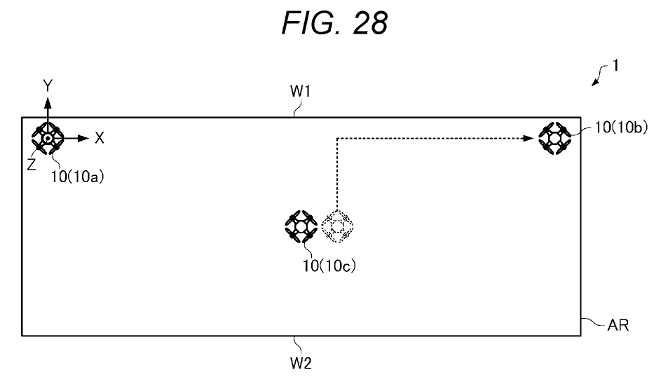

Finally, the reference station 10b transmits position information including the placement completion signal and the second coordinate to the control apparatus 20 (step S437), and ends the processing. FIG. 28 shows a state in which the placement of the reference station 10b is completed. In FIG. 28, a dashed arrow indicates a movement path of the reference station 10b.

In this way, the reference station 10b autonomously moves in the predetermined space AR after the reference station 10a acquires the first coordinate, measures the distance from the position of the reference station 10a to the position thereof, specifies the position thereof where the distance d from the position of the reference station 10a to the position thereof is equal to or greater than the predetermined value, and acquires the coordinate indicating the specified position as the second coordinate. Specifically, the reference station 10b moves in the direction opposite to the reference station 10a along the first wall W1, specifies a position where the distance d is maximized along the first wall W1 as the position thereof, and acquires the coordinate indicating the specified position as the second coordinate. In general, as the distance d between the reference station 10a and the reference station 10b increases, the positioning accuracy of the positioning target apparatus 40 increases. The predetermined value is determined according to the specification and the environment of the positioning environment providing system 1, and may be, for example, a value that satisfies required positioning accuracy. Since the stop position of the reference station 10b is a position where the distance d is maximized, the stop position is a position where the distance d is equal to or greater than the predetermined value. The stop position of the reference station 10b may be a position where the distance d is equal to or greater than the predetermined value, and may not be the position where the distance d is maximized.

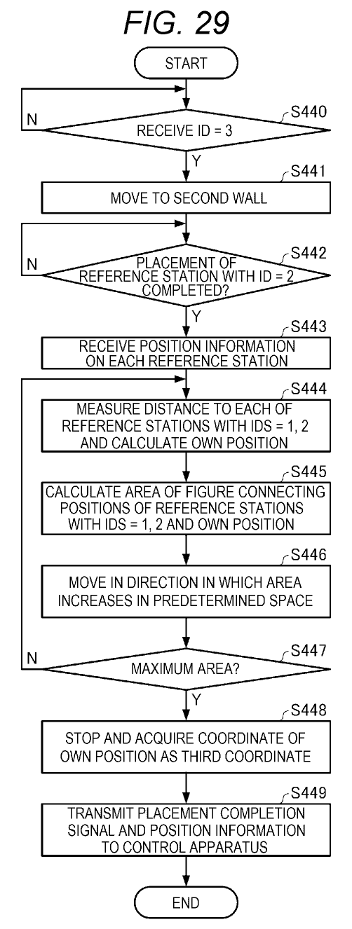

FIG. 29 is a flowchart showing a processing procedure of step S14 in FIG. 7 by the reference station 10c to which ID = 3 is assigned in the second embodiment. As shown in FIG. 29, first, the reference station 10c stands by until ID = 3 is received (N in step S440) and moves, when ID = 3 is received (Y in step S440), to a second wall W2 facing the first wall W1 in the space AR (step S441). For example, the reference station 10c stands by in the vicinity of the center of the space AR and moves from a standby position toward the second wall W2. The standby position of the reference station 10c may not be in the vicinity of the center of the space AR, and any position in the space AR can be set as the standby position. By receiving ID = 3, ID = 3 is assigned to the reference station 10c, and thereafter, communication with the reference station 10c is performed using ID = 3.

Next, when the placement of the reference station 10b with ID = 2 is completed (Y in step S442), the reference station 10c receives the position information on each reference station 10 (step S443).

Next, the reference station 10c measures a distance to each of the reference stations 10a and 10b with IDs = 1, 2, and calculates the position thereof (step S444). Specifically, the reference station 10c transmits a predetermined distance measurement signal to each of the reference stations 10a and 10b, and measures the distance to each of the reference stations 10a and 10b based on a time until the distance measurement signal transmitted to each of the reference stations 10a and 10b is returned. Then, the reference station 10c calculates the position thereof based on each position of the reference stations 10a and 10b received in step S443 and the measured distance to each of the reference stations 10a and 10b.

Next, the reference station 10c calculates the area S of a figure connecting each position of the reference stations 10a and 10b with IDs = 1, 2 received in step S443 and the position thereof calculated in step S444 (step S445).

Next, the reference station 10c moves in a direction in which the area S increases in the predetermined space AR (step S446). The reference station 10c repeats the processing of steps S444 to S446 until the area S is maximized (N in step S447).

When the area S is maximized (Y in step S447), the reference station 10c stops and acquires a coordinate of the position thereof as the third coordinate (step S448). The reference station 10c may stop in the air while rotating the blade 123, and it is preferable to land on a floor, a shelf, or the like and stop in order to reduce consumption of the battery 122.

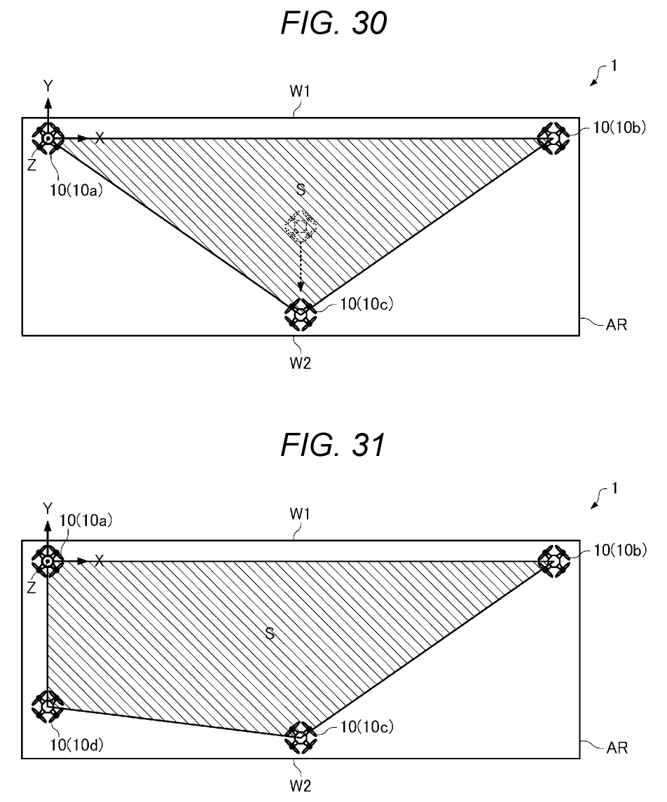

Finally, the reference station 10c transmits position information including the placement completion signal and the third coordinate to the control apparatus 20 (step S449), and ends the processing. FIG. 30 shows a state in which the placement of the reference station 10c is completed. In FIG. 30, a dashed arrow indicates a movement path of the reference station 10c.

In this way, the reference station 10c autonomously moves in the predetermined space AR after the reference station 10b acquires the second coordinate, communicates with each of the reference stations 10a and 10b to acquire the first coordinate and the second coordinate, specifies the position thereof where the area S of a triangle, which is a figure connecting the position indicated by the first coordinate, the position indicated by the second coordinate, and the position thereof, is equal to or greater than a predetermined value, and acquires the coordinate indicating the specified position as the third coordinate. The reference station 10c moves to the second wall W2 facing the first wall W1 and specifies a position along the second wall W2 as the position thereof. Specifically, the reference station 10c specifies a position where the area S is maximized along the second wall W2 as the position thereof, and acquires the coordinate indicating the specified position as the third coordinate. In general, as the area S of the figure connecting the positions of the reference stations 10a, 10b, and 10c increases, the positioning accuracy of the positioning target apparatus 40 tends to increase. The predetermined value is determined according to the specification and the environment of the positioning environment providing system 1, and may be, for example, a value that satisfies required positioning accuracy. Since the stop position of the reference station 10c is a position where the area S is maximized, the stop position is a position where the area S is equal to or greater than the predetermined value. The stop position of the reference station 10c may be a position where the area S is equal to or greater than the predetermined value, and may not be the position where the area S is maximized.

Since a flowchart showing a processing procedure of step S18 in FIG. 7 by each of the reference stations 10 to which IDs = 4 to n are assigned is the same as that in FIG. 15, illustration and description thereof will be omitted. FIG. 31 shows a state in which placement of the reference station 10d with ID = 4 is completed.

The reference station 10d with ID = 4 communicates with each of the reference stations 10a, 10b, and 10c with IDs = 1, 2, 3 to acquire the first coordinate, the second coordinate, and the third coordinate, measures the first distance from the position of the reference station 10a indicated by the first coordinate to the position thereof, the second distance from the position of the reference station 10b indicated by the second coordinate to the position thereof, and the third distance from the position of the reference station 10c indicated by the third coordinate to the position thereof, and acquires the fourth coordinate indicating the position thereof based on the first coordinate, the second coordinate, the third coordinate, the first distance, the second distance, and the third distance. Specifically, the reference station 10d autonomously moves in the predetermined space AR after the reference station 10c acquires the third coordinate, communicates with each of the reference stations 10a, 10b, and 10c to acquire the first coordinate, the second coordinate, and the third coordinate, specifies, in the predetermined space AR, the position thereof where the area S of a quadrangle that is a figure connecting the position of the reference station 10a indicated by the first coordinate, the position of the reference station 10b indicated by the second coordinate, the position of the reference station 10c indicated by the third coordinate, and the position thereof is equal to or greater than a predetermined value, and acquires the coordinate indicating the specified position as the fourth coordinate. In general, as the area S of the figure connecting the positions of the reference stations 10a, 10b, 10c, and 10d increases, the positioning accuracy of the positioning target apparatus 40 tends to increase. The predetermined value is determined according to the specification and the environment of the positioning environment providing system 1, and may be, for example, a value that satisfies required positioning accuracy. Since the stop position of the reference station 10d is a position where the area S is maximized, the stop position is a position where the area S is equal to or greater than the predetermined value. The stop position of the reference station 10d may be a position where the area S is equal to or greater than the predetermined value, and may not be the position where the area S is maximized.

In the second embodiment, since a flowchart showing the procedure of the positioning step S2 in FIG. 6 is the same as that in FIGS. 17 and 18, illustration and description thereof will be omitted. In addition, in the second embodiment, since a flowchart showing the procedure of the maintenance step S3 in FIG. 6 is the same as that in FIGS. 17 and 18, illustration and description thereof will be omitted.

According to the positioning environment providing system 1 of the second embodiment described above, for example, even when a satellite signal radio wave cannot reach the space AR, the reference stations 10a and 10b can move along the first wall W1 and specify the position along the first wall W1 as the positions thereof, and the reference station 10c can move toward the second wall W2 and specify the position along the second wall W2 as the position thereof.

According to the positioning environment providing system 1 of the second embodiment, since the reference station 10b specifies the position thereof where the distance from the position of the reference station 10a to the position thereof is equal to or greater than the predetermined value and thus the reference stations 10a and 10b are placed apart from each other, a difference between the first coordinate and the second coordinate increases, and it is possible to provide the positioning environment with high accuracy.

According to the positioning environment providing system 1 of the second embodiment, since the reference station 10c specifies the position thereof where the area of the figure connecting the positions indicated by the first coordinate and the second coordinate and the position thereof is equal to or greater than the predetermined value and thus the reference stations 10a, 10b, and 10c are placed apart from each other, a difference among the first coordinate, the second coordinate, and the third coordinate increases, and it is possible to provide the positioning environment with high accuracy.

According to the positioning environment providing system 1 of the second embodiment, the reference station 10c moves toward the second wall W2 facing the first wall W1 and specifies the position along the second wall W2 as the position thereof, and thus it is easy to place the reference station 10c away from the reference stations 10a and 10b.

According to the positioning environment providing system 1 of the second embodiment, similarly to the first embodiment, the reference station 10d autonomously moves in the space AR and acquires the fourth coordinate indicating the position thereof based on the positions of the reference stations 10a, 10b, and 10c, and thus it is possible to provide the positioning environment with high accuracy based on the first coordinate, the second coordinate, the third coordinate, and the fourth coordinate. In particular, since the reference station 10d specifies the position thereof where the area of the figure connecting the positions indicated by the first coordinate, the second coordinate, and the third coordinate and the position thereof is equal to or greater than the predetermined value and thus the reference stations 10a, 10b, 10c, and 10d are placed apart from each other, a difference among the first coordinate, the second coordinate, the third coordinate, the fourth coordinate increases, and it is possible to provide the positioning environment with high accuracy.

According to the positioning environment providing system 1 of the second embodiment, similarly to the first embodiment, each reference station 10 can autonomously move based on the remaining level of the battery 122 thereof and charge the battery 122 by being replaced with the exchange device 50 whose battery 122 is sufficiently charged. For example, when the remaining level of the battery 122 of the reference station 10a is high, the reference station 10a is not replaced with the exchange device 50, when the remaining level of the battery 122 of the reference station 10a is low, the reference station 10a is replaced with the exchange device 50 and charged, and when the remaining level of the battery 122 of the reference station 10a is medium, if the remaining level of the battery 122 of any of the reference stations 10b to 10f is not high, the reference station 10a can be replaced with the exchange device 50 and charged before the charging apparatus 30 is occupied by any of the reference stations 10b to 10f.

The disclosure is not limited to the embodiments, and various modifications can be implemented within the scope of the gist of the disclosure.

The embodiments and the modifications described above are illustrative only, and the disclosure is not limited thereto. For example, the embodiments and the modifications can be combined as appropriate.

The disclosure includes substantially the same configurations as the configurations described in the embodiments, such as configurations having the same functions, methods, and results, or configurations having the same objects and effects. In addition, the disclosure includes configurations obtained by replacing non-essential portions of the configurations described in the embodiments. In addition, the disclosure includes configurations that exert the same functions and effects or configurations that can achieve the same objects as those of the configurations described in the embodiments. In addition, the disclosure includes configurations obtained by adding a known technique to the configurations described in the embodiments.

The following contents can be derived from the embodiments and modifications described above.

One aspect of a positioning environment providing system is

a positioning environment providing system that provides, using a plurality of reference stations, an environment for measuring a position of a positioning target apparatus in a predetermined space, in which

the plurality of reference stations include a first reference station, a second reference station, and a third reference station,

the first reference station is autonomously movable in the predetermined space and acquires a first coordinate indicating a position of the first reference station,

the second reference station is autonomously movable in the predetermined space and communicates with the first reference station to acquire a second coordinate indicating a position of the second reference station based on the first coordinate, and

the third reference station is autonomously movable in the predetermined space and communicates with the first reference station and the second reference station to acquire a third coordinate indicating a position of the third reference station based on the first coordinate and the second coordinate.

According to the positioning environment providing system, since each of the first reference station, the second reference station, and the third reference station autonomously moves in the predetermined space and acquires the first coordinate, the second coordinate, and the third coordinate indicating the positions thereof, it is possible to reduce man-hours required to provide a positioning environment.

In the aspect of the positioning environment providing system,

the first reference station may receive a satellite signal transmitted from a satellite, specify, in the predetermined space, a position where a reception strength of the satellite signal is equal to or greater than a predetermined value as the position of the first reference station, and acquire a coordinate indicating the specified position as the first coordinate.

According to the positioning environment providing system, since the first reference station can acquire the highly accurate first coordinate at the position where the satellite signal reception strength is equal to or greater than the predetermined value, it is possible to provide the positioning environment with high accuracy.

In the aspect of the positioning environment providing system,

the second reference station may receive a satellite signal transmitted from a satellite, autonomously move in the predetermined space after the first reference station acquires the first coordinate, communicate with the first reference station to acquire the first coordinate, measure a distance from the position indicated by the first coordinate to the position of the second reference station, specify, in a receivable area of the satellite signal in the predetermined space, the position of the second reference station such that the distance from the position indicated by the first coordinate to the position of the second reference station is equal to or greater than a predetermined value, and acquire a coordinate indicating the specified position as the second coordinate.

According to the positioning environment providing system, since the first reference station and the second reference station are placed apart from each other in the satellite signal receivable area, a difference between the first coordinate and the second coordinate increases, and thus it is possible to provide the positioning environment with high accuracy.

In the aspect of the positioning environment providing system,

the third reference station may receive a satellite signal transmitted from a satellite, autonomously move in the predetermined space after the second reference station acquires the second coordinate, communicate with each of the first reference station and the second reference station to acquire the first coordinate and the second coordinate, specify, in a receivable area of the satellite signal, the position of the third reference station where an area of a figure connecting the position indicated by the first coordinate, the position indicated by the second coordinate, and the position of the third reference station is equal to or greater than a predetermined value, and acquire a coordinate indicating the specified position as the third coordinate.

According to the positioning environment providing system, since the first reference station, the second reference station, and the third reference station are placed apart from each other in the satellite signal receivable area, a difference among the first coordinate, the second coordinate, and the third coordinate increases, and thus it is possible to provide the positioning environment with high accuracy.

In the aspect of the positioning environment providing system,

the predetermined space may be an indoor space, the first reference station may move along a first wall, specify a position along the first wall as the position of the first reference station, and acquire a coordinate indicating the specified position as the first coordinate.

According to the positioning environment providing system, for example, even when a satellite signal radio wave cannot reach the predetermined space, the position along the first wall can be specified as the position of the first reference station.

In the aspect of the positioning environment providing system,

the second reference station may autonomously move in the predetermined space after the first reference station acquires the first coordinate, measure a distance from the position of the first reference station to the position of the second reference station, specify the position of the second reference station such that the distance from the position of the first reference station to the position of the second reference station is equal to or greater than a predetermined value, and acquire a coordinate indicating the specified position as the second coordinate.

According to the positioning environment providing system, since the first reference station and the second reference station are placed apart from each other, the difference between the first coordinate and the second coordinate increases, and thus it is possible to provide the positioning environment with high accuracy.

In the aspect of the positioning environment providing system,

the third reference station may autonomously move in the predetermined space after the second reference station acquires the second coordinate, communicate with each of the first reference station and the second reference station to acquire the first coordinate and the second coordinate, specify the position of the third reference station where an area of a figure connecting the position indicated by the first coordinate, the position indicated by the second coordinate, and the position of the third reference station is equal to or greater than a predetermined value, and acquire a coordinate indicating the specified position as the third coordinate.

According to the positioning environment providing system, since the first reference station, the second reference station, and the third reference station are placed apart from each other, the difference among the first coordinate, the second coordinate, and the third coordinate increases, and thus it is possible to provide the positioning environment with high accuracy.

In the aspect of the positioning environment providing system,

the third reference station may specify a position along a second wall facing the first wall as the position of the third reference station.

According to the positioning environment providing system, it is easy to place the third reference station away from the first reference station and the second reference station.

In the aspect of the positioning environment providing system,

the plurality of reference stations may include a fourth reference station, and

the fourth reference station may communicate with each of the first reference station, the second reference station, and the third reference station to acquire the first coordinate, the second coordinate, and the third coordinate, measure a first distance from the position indicated by the first coordinate to a position of the fourth reference station, a second distance from the position indicated by the second coordinate to the position of the fourth reference station, and a third distance from the position indicated by the third coordinate to the position of the fourth reference station, and acquire a fourth coordinate indicating the position of the fourth reference station based on the first coordinate, the second coordinate, the third coordinate, the first distance, the second distance, and the third distance.

According to the positioning environment providing system, the fourth coordinate indicating the position of the fourth reference station can be acquired based on the position of the first reference station, the position of the second reference station, and the position of the third reference station, and it is possible to provide the positioning environment with high accuracy based on the first coordinate, the second coordinate, the third coordinate, and the fourth coordinate.

In the aspect of the positioning environment providing system,

the fourth reference station may autonomously move in the predetermined space after the third reference station acquires the third coordinate, specify, in the predetermined space, the position of the fourth reference station where an area of a figure connecting the position indicated by the first coordinate, the position indicated by the second coordinate, the position indicated by the third coordinate, and the position of the fourth reference station is equal to or greater than a predetermined value, and acquire a coordinate indicating the specified position as the fourth coordinate.

According to the positioning environment providing system, since the first reference station, the second reference station, the third reference station, and the fourth reference station are placed apart from each other, a difference among the first coordinate, the second coordinate, the third coordinate, and the fourth coordinate increases, and thus it is possible to provide the positioning environment with high accuracy.

In the aspect of the positioning environment providing system,

an exchange device that is autonomously movable and is located at a position where electric power is suppliable from a charging apparatus may be provided, the first reference station may calculate a remaining battery level of the first reference station and communicate with the exchange device based on the remaining battery level of the first reference station, and the exchange device may move to the position indicated by the first coordinate.

According to the positioning environment providing system, based on the remaining battery level thereof, the first reference station can be replaced with the exchange device to which the electric power is supplied from the charging apparatus.

In the aspect of the positioning environment providing system,

a remaining battery level of the exchange device may be equal to or greater than a predetermined value.

According to the positioning environment providing system, the exchange device whose battery is sufficiently charged can be replaced with the first reference station.

In the aspect of the positioning environment providing system,

the first reference station may move to the position where the electric power is suppliable from the charging apparatus.

According to the positioning environment providing system, the first reference station can be charged by being replaced with the exchange device.

In the aspect of the positioning environment providing system,

the second reference station may calculate a remaining battery level of the second reference station, and

the first reference station may acquire information on the remaining battery level of the second reference station from the second reference station, not move when the remaining battery level of the first reference station is a first level, and move to the position where the electric power is suppliable from the charging apparatus when the remaining battery level of the first reference station is a second level lower than the first level and the remaining battery level of the second reference station is the second level or a third level lower than the second level, or when the remaining battery level of the first reference station is the third level.

According to the positioning environment providing system, the first reference station is not replaced with the exchange device when the remaining battery level of the first reference station is high, the first reference station is replaced with the exchange device and charged when the remaining battery level of the first reference station is low, and the first reference station is replaced with the exchange device and charged when the remaining battery level of the first reference station is medium if the remaining battery level of the second reference station is not high.

One aspect of a positioning environment providing method is

a positioning environment providing method that provides, using a plurality of reference stations, an environment for measuring a position of a positioning target apparatus in a predetermined space, the positioning environment providing method including:

causing a first reference station among the plurality of reference stations to autonomously move in the predetermined space and acquire a first coordinate indicating a position of the first reference station;

causing a second reference station among the plurality of reference stations to autonomously move in the predetermined space and communicate with the first reference station to acquire a second coordinate indicating a position of the second reference station based on the first coordinate; and

causing a third reference station among the plurality of reference stations to autonomously move in the predetermined space and communicate with the first reference station and the second reference station to acquire a third coordinate indicating a position of the third reference station based on the first coordinate and the second coordinate.

According to the positioning environment providing method, since each of the first reference station, the second reference station, and the third reference station autonomously moves in the predetermined space and acquires the first coordinate, the second coordinate, and the third coordinate indicating the positions thereof, it is possible to reduce man-hours required to provide a positioning environment.

What is claimed is:

1. A positioning environment providing system that provides, using a plurality of reference stations, an environment for measuring a position of a positioning target apparatus in a predetermined space, wherein
the plurality of reference stations include a first reference station, a second reference station, and a third reference station,
the first reference station is autonomously movable in the predetermined space and acquires a first coordinate indicating a position of the first reference station,
the second reference station is autonomously movable in the predetermined space and communicates with the first reference station to acquire a second coordinate indicating a position of the second reference station based on the first coordinate, and
the third reference station is autonomously movable in the predetermined space and communicates with the first reference station and the second reference station to acquire a third coordinate indicating a position of the third reference station based on the first coordinate and the second coordinate.

2. The positioning environment providing system according to claim 1, wherein
the first reference station receives a satellite signal transmitted from a satellite, specifies, in the predetermined space, a position where a reception strength of the satellite signal is equal to or greater than a predetermined value as the position of the first reference station, and acquires a coordinate indicating the specified position as the first coordinate.

3. The positioning environment providing system according to claim 2, wherein
the second reference station receives a satellite signal transmitted from a satellite, autonomously moves in the predetermined space after the first reference station acquires the first coordinate, communicates with the first reference station to acquire the first coordinate, measures a distance from the position indicated by the first coordinate to the position of the second reference station, specifies, in a receivable area of the satellite signal in the predetermined space, the position of the second reference station such that the distance from the position indicated by the first coordinate to the position of the second reference station is equal to or greater than a predetermined value, and acquires a coordinate indicating the specified position as the second coordinate.

4. The positioning environment providing system according to claim 3, wherein
the third reference station receives a satellite signal transmitted from a satellite, autonomously moves in the predetermined space after the second reference station acquires the second coordinate, communicates with each of the first reference station and the second reference station to acquire the first coordinate and the second coordinate, specifies, in a receivable area of the satellite signal, the position of the third reference station where an area of a figure connecting the position indicated by the first coordinate, the position indicated by the second coordinate, and the position of the third reference station is equal to or greater than a predetermined value, and acquires a coordinate indicating the specified position as the third coordinate.

5. The positioning environment providing system according to claim 1, wherein
the predetermined space is an indoor space, the first reference station moves along a first wall, specifies a position along the first wall as the position of the first reference station, and acquires a coordinate indicating the specified position as the first coordinate.

6. The positioning environment providing system according to claim 5, wherein
the second reference station autonomously moves in the predetermined space after the first reference station acquires the first coordinate, measures a distance from the position of the first reference station to the position of the second reference station, specifies the position of the second reference station such that the distance from the position of the first reference station to the position of the second reference station is equal to or greater than a predetermined value, and acquires a coordinate indicating the specified position as the second coordinate.

7. The positioning environment providing system according to claim 6, wherein
the third reference station autonomously moves in the predetermined space after the second reference station acquires the second coordinate, communicates with each of the first reference station and the second reference station to acquire the first coordinate and the second coordinate, specifies the position of the third reference station where an area of a figure connecting the position indicated by the first coordinate, the position indicated by the second coordinate, and the position of the third reference station is equal to or greater than a predetermined value, and acquires a coordinate indicating the specified position as the third coordinate.

8. The positioning environment providing system according to claim 7, wherein
the third reference station specifies a position along a second wall facing the first wall as the position of the third reference station.

9. The positioning environment providing system according to claim 1, wherein
the plurality of reference stations include a fourth reference station, and
the fourth reference station communicates with each of the first reference station, the second reference station, and the third reference station to acquire the first coordinate, the second coordinate, and the third coordinate, measures a first distance from the position indicated by the first coordinate to a position of the fourth reference station, a second distance from the position indicated by the second coordinate to the position of the fourth reference station, and a third distance from the position indicated by the third coordinate to the position of the fourth reference station, and acquires a fourth coordinate indicating the position of the fourth reference station based on the first coordinate, the second coordinate, the third coordinate, the first distance, the second distance, and the third distance.

10. The positioning environment providing system according to claim 9, wherein
the fourth reference station autonomously moves in the predetermined space after the third reference station acquires the third coordinate, specifies, in the predetermined space, the position of the fourth reference station where an area of a figure connecting the position indicated by the first coordinate, the position indicated by the second coordinate, the position indicated by the third coordinate, and the position of the fourth reference station is equal to or greater than a predetermined value, and acquires a coordinate indicating the specified position as the fourth coordinate.

11. The positioning environment providing system according to claim 10, further comprising:
an exchange device that is autonomously movable and is located at a position where electric power is suppliable from a charging apparatus, wherein
the first reference station calculates a remaining battery level of the first reference station and communicates with the exchange device based on the remaining battery level of the first reference station, and the exchange device moves to the position indicated by the first coordinate.

12. The positioning environment providing system according to claim 11, wherein
a remaining battery level of the exchange device is equal to or greater than a predetermined value.

13. The positioning environment providing system according to claim 12, wherein
the first reference station moves to the position where the electric power is suppliable from the charging apparatus.

14. The positioning environment providing system according to claim 13, wherein
the second reference station calculates a remaining battery level of the second reference station, and
the first reference station acquires information on the remaining battery level of the second reference station from the second reference station, does not move when the remaining battery level of the first reference station is a first level, and moves to the position where the electric power is suppliable from the charging apparatus when the remaining battery level of the first reference station is a second level lower than the first level and the remaining battery level of the second reference station is the second level or a third level lower than the second level, or when the remaining battery level of the first reference station is the third level.

15. A positioning environment providing method that provides, using a plurality of reference stations, an environment for measuring a position of a positioning target apparatus in a predetermined space, the positioning environment providing method comprising:
causing a first reference station among the plurality of reference stations to autonomously move in the predetermined space and acquire a first coordinate indicating a position of the first reference station;
causing a second reference station among the plurality of reference stations to autonomously move in the predetermined space and communicate with the first reference station to acquire a second coordinate indicating a position of the second reference station based on the first coordinate; and
causing a third reference station among the plurality of reference stations to autonomously move in the predetermined space and communicate with the first reference station and the second reference station to acquire a third coordinate indicating a position of the third reference station based on the first coordinate and the second coordinate.
